(19) United States
(12) Patent Application Publication
(10) Pub. No.: US 2007/0002737 A1
(43) Pub. Date: Jan. 4, 2007

(54) Access control dissemination

(76) Inventors: Manoj Paul, Bangalore (IN); Udaya Shankara, Bangalore (IN)

Correspondence Address: SCHWEGMAN, LUNDBERG, WOESSNER & KLUTH, P.A., P.O. BOX 2938, MINNEAPOLIS, MN, 55402, US

(21) Appl. No.: 11/169,507

(22) Filed: Jun. 29, 2005

(51) Int. Cl. H04L 1/00

(52) U.S. Cl. 370/230

(57) ABSTRACT

Apparatus and systems, as well as methods and articles, may operate to propagate an access control rule throughout a bridged network as part of a generic attribute registration protocol.

### TECHNICAL FIELD

Various embodiments described herein relate to communication technology generally, including apparatus, systems, and methods used in controlling access within networked environments.

### BACKGROUND INFORMATION

The enforcement of configured access control rules in specific network nodes may be used to prevent access to a selected network or services provided within the network. In some cases, the rules may be enforced at arbitrary locations.

For example, in a bridged local area network (LAN), the administrator may wish to prevent packets flowing from a selected source MAC (media access control) address to a selected destination MAC address. To accomplish this goal, one or more access control rules may be configured for enforcement in one of the network bridges. These rules, when applied to the frames received on a bridge port, can be used to determine whether the frame is accepted (e.g., processed and forwarded), or denied (e.g., dropped).

Since the enforcement location of access control rules may be arbitrary, it is entirely possible to have access rules operating to terminate the flow of frames near the destination node, rather than the source node. Frames that are ultimately dropped may thus propagate through much of the network, reducing overall network throughput.

### BRIEF DESCRIPTION OF THE DRAWINGS

FIG. 1A illustrates a protocol data unit structure according to various embodiments of the invention.

FIG. 1B is a block diagram of apparatus and systems according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

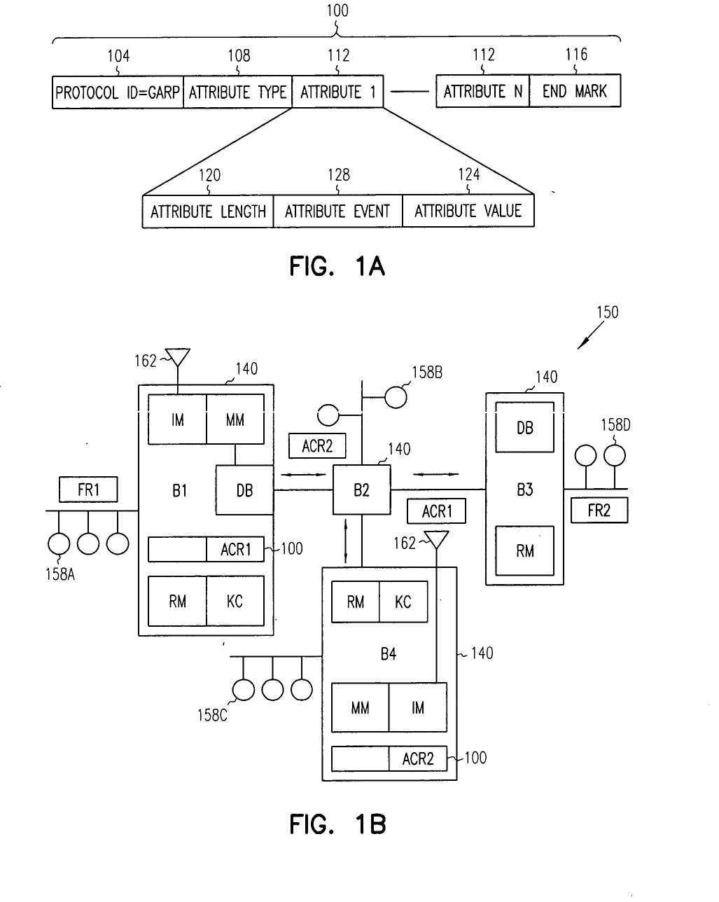

FIG. 1A illustrates a protocol data unit (PDU) 100 structure according to various embodiments of the invention. This PDU 100 structure, if propagated throughout a network, may increase the efficiency of access control operations within the network, including bridged local area network (LAN) environments. The increase in efficiency may occur since it is often more efficient to terminate the flow of frames based on an access rule located close to the point of origination, rather than near the ultimate destination.

In some embodiments, access control rules (e.g., encapsulated in the PDU 100) may be disseminated across various nodes in a network. For example, in a bridged network, bridges can exchange the access control rules configured at one bridge. Once dissemination occurs, the probability of terminating undesired flow into the network at the point of origination may increase substantially.

A generic attribute registration protocol (GARP), such as the GARP defined in the Institute of Electrical and Electronic Engineers (IEEE) 802.1p extension of the IEEE 802.1D standard, can provides a framework to propagate attributes, and values for the attributes, across bridges in a bridged LAN. For more information regarding the IEEE 802.1 standard and its extensions, please refer to LAN/MAN Bridging & Management (802.1), IEEE 802.1D-2004 IEEE Standard for Local and Metropolitan Area Networks--Media access control (MAC) Bridges, published Jun. 09, 2004, and related revisions.

In some embodiments, a GARP may be used to implement a generic access control registration protocol (GACRP). Thus, GACRP applications running on various bridges in a bridged LAN can be used to propagate access control rules configured on a given bridge to all other nodes in the network.

The PDU 100 structure of FIG. 1A may include a Protocol ID field 104, set to indicate “GARP”; an Attribute Type field 108, set to indicate “Access Control Rule”; one or more Attribute fields 112; and an End Mark field 116 (that may be set to zero).

The Attribute length sub-field 120 of the Attribute field 112 may be set to indicated the length of the Attribute Value field 124. The Attribute Event sub-field 128 may be set to reflecdt one of the events defined by a GARP (e.g., the IEEE 802.1p standard, wherein the Attribute Event may be selected as shown in Table I), indicating how the conent of the Attribute Value sub-field 124 is to be processed. The Attribute Value sub-field 124, which may include the access control rule (ACR) itself, can include the rule content (e.g., indicating frame acceptance, or frame denial), and a key associated with the rule.

TABLE I

| ATTRIBUTE EVENT VALUE | IEEE 802.1P OPERATORS |
|---|---|
| 0 | Leave All |
| 1 | Join_Empty Operator |
| 2 | Join_In Operator |
| 3 | Leave_Empty Operator |
| 4 | Leave_In Operator |
| 5 | Empty Operator |

The Attribute Event sub-field 128 parameter may be used to determine whether an ACR has been added to or deleted from the system. The Join_Empty/Join_In operator may be used when a bridge with a new ACR attempts to register the Attribute including the ACR as a member of the network. The Leave_Empty/Leave_In operator may be used when a bridge wants to withdraw its declaration for a given ACR (e.g., remove the ACR as a member of the network). The LeaveAll operator may be sent periodically to selected network nodes, enabling them to send their registered ACRs to other nodes in the network.

FIG. 1B is a block diagram of apparatus 140 and systems 150 according to various embodiments of the invention. In a bridged network 154, an access control rule (ACR) ACR1 may be configured as part of a PDU at apparatus 140, which may comprise a bridge B1. The ACR ACR1 may then be propagated throughout the bridged network 154 among the bridges B2, B3, and B4 by using the GACRP described herein. Once propagation is complete, the bridges B2, B3, B4 and other bridges (not shown) can apply the ACR directly to frames FR1, FR2, for example, originating from various hosts 158A, 158D directly connected to the bridge ports.

In some embodiments an ACR ACR1 may first be populated at the bridge B1. Then the bridge B1 may send a GACRP message (e.g., including the PDU 100) to other bridges, such as bridge B2, to propagate the ACR. As is known to those of skill in the art, the operation of a GARP will then effect propagation of the ACR throughout the bridged network 154, and bridge B3, for example, may apply the ACR for frames FR2 originating from its own connected hosts 158D.

Thus, an apparatus 140 may include one or more message initiation modules IM to couple to a bridged network 154 and to transmit an ACR ACR1 to a plurality of bridges B2, B3, B4 included in the bridged network 154. The message initiation module IM may be used to encapsulate the ACR in a PDU formatted according to an IEEE 802.1 standard, as described with respect to FIG. 1A.

An apparatus 140 may include a bridge B1, as well as the message initiation module IM. The apparatus 140 may also include a switch or a hub, along with the message initiation module IM.

In some embodiments, the apparatus 140 may include a bridge B1, having a message initiation module IM and a relay module RM to receive another ACR ACR2 from a another message initiation module IM forming part of another bridge B4 included in the plurality of bridges B2, B3, and B4.

An ACR database DB, included in the apparatus 140, may be used to store one or more ACRs (e.g., ACR1 and ACR2). To determine whether a particular ACR has already been registered in the ACR database DB, an apparatus 140 may include a key comparison module KC coupled to the relay module RM to compare a key associated with the ACR with other keys (e.g., a key already stored in the database DB).

Other embodiments may be realized. For example, a system 150 may include one or more of the apparatus 140, as previously described. The system 150 may also include one or more message initiation modules IMs operating as described above, as well as a memory MM, including a read only memory, an electrically-erasable read-only memory, a polymer memory, and/or a flash memory, to store ACRs, including storing the ACRs as part of an ACR database DB populated with a plurality of ACRs (e.g., ACR1, ACR2).

In some embodiments, the system 150 may include a plurality of relay bridges B2, B3, B4 in the bridged network 154. The relay bridges B2, B3, B4 may in turn include one or more message relay modules RMs and one or more ACR databases DB to receive ACRs and to populate the ACR databases DB with the received ACRs as needed.

While various embodiments have been described with respect to wired networks, some embodiments of the system 150 may operate in conjunction with a wireless network, such that an antenna 162 is coupled to the message initiation module IM, either directly, or indirectly, perhaps through a processor and/or a transceiver (not shown). The antenna 162 may comprise a dipole antenna, a monopole antenna, an omnidirectional antenna, a stripline antenna, and a patch antenna, among others.

Any of the components previously described can be implemented in a number of ways, including simulation via software. Thus, the PDU 100; Protocol ID field 104; Attribute Type field 108; Attribute fields 112; End Mark field 116; Attribute Length sub-field 120; Attribute Value field 124; Attribute Event sub-field 128; Join_Empty/Join_In operators; Leave_Empty/Leave_In operators; LeaveAll operator; apparatus 140; systems 150; bridged network 154; hosts 158A, 158B, 158C, 158D; antennas 162; ACRs ACR1, ACR2; bridges B1, B2, B3, B4; database DB; frames FR1, FR2; key comparison module KC; memory MM; message initiation modules IM; and relay modules RM may all be characterized as “modules” herein. The modules may include hardware circuitry, single or multi-processor circuits, memory circuits, software program modules and objects, firmware, and combinations thereof, as desired by the architect of the apparatus 140 and systems 150 and as appropriate for particular implementations of various embodiments. The modules may be included in a system operation simulation package such as a software electrical signal simulation package, a power usage and distribution simulation package, a network security simulation package, a power/heat dissipation simulation package, a signal transmission-reception simulation package, or any combination of software and hardware used to simulate the operation of various potential embodiments. Such simulations may be used to characterize or test the embodiments, for example.

It should also be understood that the apparatus and systems of various embodiments can be used in applications other than propagating access control rules within a bridged network. Thus, various embodiments of the invention are not to be so limited. The illustrations of apparatus 140 and system 150 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, and application-specific modules, including multilayer, multi-chip modules. Such apparatus and systems may further be included as sub-components within a variety of electronic systems, such as data bridges, switches, and hubs; televisions and cellular telephones; personal computers and workstations; radios and video players; and vehicles, among others.

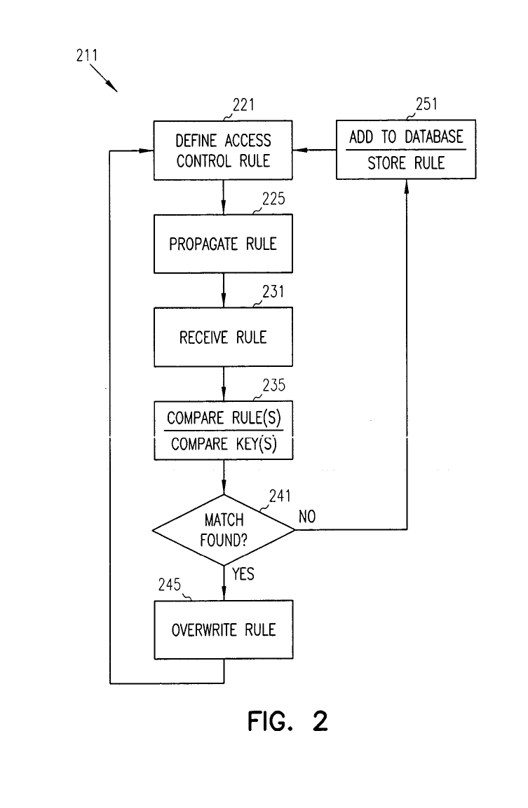

Some embodiments may include a number of methods. For example, FIG. 2 is a flow diagram illustrating several methods 211 according to various embodiments of the invention. Thus, a method 211 may begin at block 221 with defining an ACR, and then continue with propagating the ACR throughout a bridged network as part of a GARP at block 225. The GARP may include an IEEE 802.1 standard defining a PDU to carry the ACR. Defining the ACR at block 221 may include defining access control as an attribute in the PDU, and defining the ACR as a value of the attribute. As noted above, the ACR may include a key and rule content designating acceptance or denial.

The method 211 may include receiving the ACR at block 231, perhaps at a bridge, and then, at block 235, comparing the ACR with other ACRs included in an ACR database, which may also be included in the bridge. Thus, the method 211 may include receiving the ACR at each bridge included in the bridged network except for the initiation bridge used to transmit the access control rule at block 231. The method 211 may also include comparing the ACR to a plurality of ACRs included in an ACR database at block 235.

Comparing the ACR with other ACRs at block 235 may include comparing ACR keys to determine whether to add the newly-received ACR to an ACR database. Thus, the method 211 may include comparing a key associated with the newly-received ACR with other keys associated with the other ACRs in the database. If a key match is found at block 241, then the method 211 may include overwriting one of the other ACRs (e.g., an ACR having the matching key) with the newly-received ACR at block 245.

The method 211 may also include failing to find a second key in the ACR database corresponding to (e.g., matching) the key included in the newly-received ACR. Thus, if no match is found at block 241, the method 211 may include adding the newly-received ACR to the ACR database, perhaps by storing the ACR in the database without overwriting another ACR, at block 251.

Thus, in some embodiments, the methods 211 described herein can apply a GARP to efficiently disseminate ACRs in a bridged network. Better network security may result if the ACRs are disseminated throughout the network, instead of residing in arbitrary locations (e.g., only in the bridges where they were configured). This is because malicious frames may then be terminated at the point of origination, before being permitted to enter the network.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

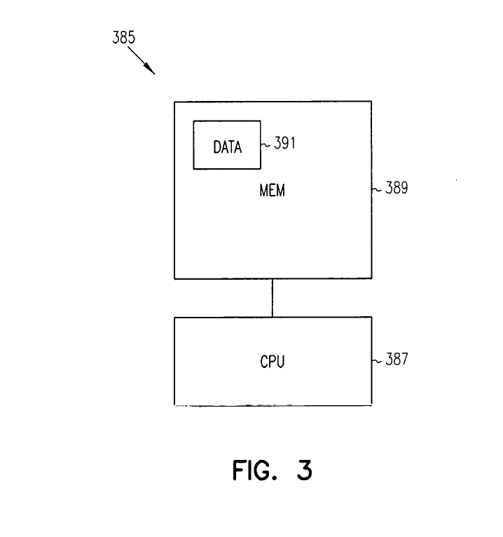

Thus, other embodiments may be realized. For example, FIG. 3 is a block diagram of an article 385 according to various embodiments of the invention. Examples disk, some other storage device, or any type of electronic device or system. The article 385 may include one or more processor(s) 387 coupled to a machine-accessible medium such as a memory 389 (e.g., a memory including an electrical, optical, or electromagnetic conductor, including a flash memory). The medium may contain associated information 391 (e.g., computer program instructions, data, or both) which, when accessed, results in a machine (e.g., the processor(s) 387) defining access control as an attribute in a PDU, defining the ACR as a value of the attribute, and propagating the ACR throughout a bridged network as part of a GARP.

Other activities may include receiving the propagated ACR at each bridge included in a bridged network (except for the initiation bridge used to transmit the ACR), and comparing the ACR to a plurality of ACRs included in an ACR database. Further activities may include comparing ACR keys to determine whether to add the ACR to the ACR database.

Implementing the apparatus, systems, and methods disclosed herein may operate to improve overall bandwidth utilization of a bridged network by terminating frames at the point of origination, preventing some portion of unnecessary traffic flow within the network. Administrators may now be able to populate selected ACRs at any one of the nodes in a network, with some of the embodiments serving to permit propagation of those ACRs across the entire network.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a first message initiation module to couple to a bridged network and to transmit an access control rule to a plurality of bridges included in the bridged network.

2. The apparatus of claim 1, further including:
a bridge including the first message initiation module.

3. The apparatus of claim 1, further including:
one of a switch and a hub including the first message initiation module.

4. The apparatus of claim 1, further including:
a first bridge including the first message initiation module and a relay module to receive another access control rule from a second message initiation module included in a second bridge included in the plurality of bridges.

5. The apparatus of claim 4, further including:
a key comparison module coupled to the relay module to compare a key associated with the access control rule with another key.

6. The apparatus of claim 1, further including:
an access control rule database to store the access control rule.

7. The apparatus of claim 1, wherein the message initiation module is to encapsulate the access control rule in a protocol data unit formatted according to an Institute of Electrical and Electronic Engineers 802.1 standard.

8. A system, including:
a message initiation module to couple to a bridged network and to transmit an access control rule to a plurality of bridges included in the bridged network; and
a flash memory to store the access control rule.

9. The system of claim 8, further including:
an omnidirectional antenna coupled to the message initiation module.

10. The system of claim 8, further including:
a memory to store an access control rule database populated with the access control rule.

11. The system of claim 8, further including:
a plurality of relay bridges included in the bridged network, the plurality of relay bridges including a message relay module and an access control rule database to receive the access control rule and to populate the access control rule database with the access control rule.

12. A method, including:
propagating an access control rule throughout a bridged network as part of a generic attribute registration protocol.

13. The method of claim 12, wherein the generic attribute registration protocol includes an Institute of Electrical and Electronic Engineers 802.1 standard defining a protocol data unit to carry the access control rule.

14. The method of claim 12, further including:
defining access control as an attribute in a protocol data unit and defining the access control rule as a value of the attribute.

15. The method of claim 12, wherein the access control rule includes a key and content designating acceptance or denial.

16. The method of claim 12, further including:
receiving the access control rule at a bridge; and comparing the access control nile with other access control rules included in an access control rule database included in the bridge.

17. The method of claim 16, wherein comparing the access control rule with other access control rules further includes:
comparing a key associated with the access control rule with other keys associated with the other access control rules.

18. The method of claim 17, further including:
overwriting one of the other access control rules with the access control rule.

19. The method of claim 12, further including: failing to find a second key in an access control rule database corresponding to a first key included in the access control rule.

20. The method of claim 19, further including: storing the access control rule in the access control rule database.

21. An article including a machine-accessible medium having associated information, wherein the information, when accessed, results in a machine performing: propagating an access control rule throughout a bridged network as part of a generic attribute registration protocol.

22. The article of claim 21, wherein the information, when accessed, results in a machine performing:
receiving the access control rule at each bridge included in the bridged network except for an initiation bridge to transmit the access control rule; and comparing the access control rule to a plurality of access control rules included in an access control rule database.

23. The article of claim 21, wherein the information, when accessed, results in a machine performing:
defining access control as an attribute in a protocol data unit and defining the access control rule as a value of the attribute.

24. The article of claim 19, wherein the information, when accessed, results in a machine performing:
comparing access control rule keys to determine whether to add the access control rule to an access control rule database.
